(19) United States
(12) Patent Application Publication
(10) Pub. No.: US 2007/0049108 A1
(43) Pub. Date: Mar. 1, 2007

(54) Hierarchical cable harness structure for a motor vehicle

(75) Inventors: Peter Appel, Hainburg (DE); Harald Dittmann, Babenhausen (DE); Jurgen Dreyer, Schaafheim-Mosbach (DE); Heiko Schnieders, Schaafheim (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/505,733

(22) Filed: Aug. 17, 2006

(30) Foreign Application Priority Data
Aug. 31, 2005 (DE) 10 2005 041 326.9

(51) Int. Cl. H01R 11/00

(52) U.S. Cl. 439/502

(57) ABSTRACT

A cable harness for connecting electrical components in a cockpit of a motor vehicle to an on-board motor-vehicle electrical system has a cockpit cable harness with a single main connection point to the on-board vehicle electrical system. The electrical components belong to a respective one of at least two modules, and the cockpit cable harness has a module connection point to each of the at least two modules. The electrical components are connected to the module connection point by a module cable harness.

### BACKGROUND OF THE INVENTION

The invention relates to a cable harness for connecting electrical components in a cockpit of a motor vehicle to an on-board motor-vehicle electrical system, with a cockpit cable harness which has a single main connection point to the on-board vehicle electrical system.

In modern vehicles, the electrical components, for example the on-board computer, combination instrument, air-conditioning system, audio or multimedia system, navigation device, airbag controller and various operator control and display units, which are arranged in the cockpit are connected to the on-board motor-vehicle electrical system by means of a cockpit cable harness. In this case, the cockpit cable harness has a single electrical connection point to the on-board vehicle electrical system, this connection point being called the main connection point of the cockpit cable harness in the text which follows. The main connection point is generally formed by a branching point in the on-board vehicle electrical system, at which branching point one or more cable or cables branch off from the cable harness of the on-board vehicle electrical system. However, said main connection point can also be designed as a plug or socket into which a corresponding mating piece of the cockpit cable harness is inserted. Starting from the main connection point, individual cables lead to the electrical components of the cockpit, with each of the electrical components having their own interface which is different from the others. During cabling of the cockpit, one or more of the individual cables are connected to the respective interface of the electrical components, it being necessary for these individual cables to have a connection piece which matches the interface. Cabling the electrical components of the cockpit therefore requires the production of an electrical connection between each individual component and one or more associated individual cable or cables of the cockpit cable harness. The individual cables have to be correspondingly unambiguously identified in order to be correctly assigned to the associated component. Another difficulty when cabling the cockpit is that there is very little installation space and the components are situated close together, and this limits the movement play available to the person carrying out the cabling. A large cockpit cable harness which is made up of many individual cables can be handled only with difficulty under restricted conditions.

### SUMMARY OF THE INVENTION

An object of the present invention is to provide a cable harness for connecting electrical components in a cockpit of a motor vehicle to an on-board motor vehicle electrical system which can be used to reduce the outlay on cabling.

According to an embodiment of the invention, the electrical components are assigned to a respective one of at least two modules. The cockpit cable harness has a single module connection point to each of the at least two modules, so that in the simplest case the cockpit cable harness has only three connection points, namely the main connection point to the cable harness of the on-board vehicle electrical system and the two module connection points to the modules in which the electrical components are arranged. According to the invention, the electrical components are connected to the module connection point by a module cable harness of the associated module. Grouping the components to be connected into at least two modules considerably reduces the number of connection points required in the cockpit cable harness. It is expedient to group the components in this way starting with at least three electrical components. The electrical components which belong to one module can be connected to one another and to the module connection point in advance by means of the module cable harness. The modules which are cabled in advance in this way are then inserted into the vehicle cockpit, and the cockpit cable harness only needs to be laid, that is to say only the connection between the on-board vehicle electrical system and the small number of modules is to be made. The cockpit cable harness, which is reduced in size, can be handled more easily, and this reduces outlay on mounting. The insertion of module cable harnesses which are subordinate to the cockpit cable harness also facilitates servicing since only parts of the associated module cable harness have to be removed again when there is a defect in the electrical components. The cockpit cable harness, which is reduced in size, also assists handling of different cockpit variants, since it can be used in unchanged form for cockpit variants which are fitted with electrical components in various ways. A distinction is drawn by means of the modules, that is to say the respective cockpit variant is defined by means of the components which are assigned to the at least two modules and the associated module cable harness.

In a further embodiment of the invention, the principle of modularization which is applied in the cockpit cable harness is also applied to the module cable harnesses, that is to say the electrical components within one module are each assigned to one of at least two submodules, the module cable harness of the module is provided with subordinate connection points to each of the at least two submodules, and the electrical components are connected to the subordinate connection point by means of a submodule cable harness of the associated submodule. In this way, not only the cockpit cable harness but also the module cable harnesses are reduced in size. This creates a cable harness hierarchy which simplifies handling and servicing of the cabling in the vehicle cockpit overall.

In one refinement, the module and/or the submodule connection points are of identical design, in particular in the form of identical plug connectors. This reduces outlay on materials and simplifies handling during cabling and repair and maintenance operations.

If the pin assignment of the plug connectors is also identical, this has the additional advantage that it is no longer necessary to identify the cables of the cockpit cable harness which branch off to the modules.

If at least two of the electrical cables which belong to the cockpit cable harness and/or to the module cable harnesses and/or to the submodule cable harnesses are surrounded by a common covering, for example a plastic covering or insulating tape, this additionally facilitates handling.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below with reference to the drawings, in which

FIG. 1 shows a cockpit cable harness according to the prior art;

FIG. 2 shows a cockpit cable harness according to the invention; and

FIG. 3 shows a further embodiment of the cockpit cable harness according to the invention.

### DETAILED DESCRIPTION OF THE PRESENTLY PREFERRED EMBODIMENTS

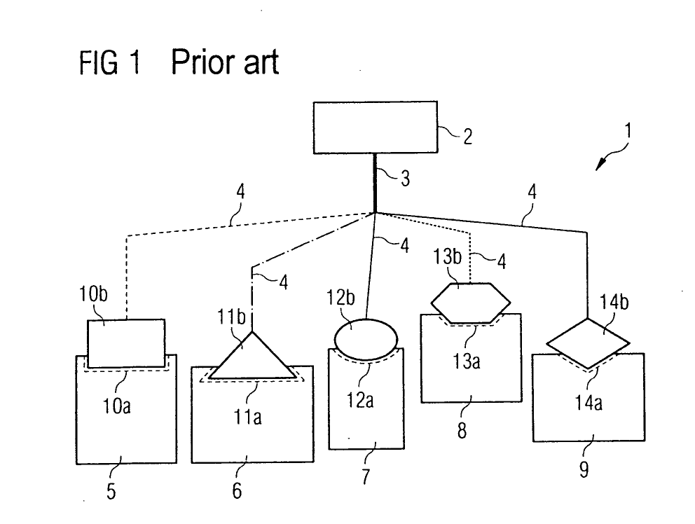

FIG. 1 illustrates a simplified cockpit cable harness 1 as is known in principle from modern motor vehicles. Starting from a main connection point 2 to the on-board motor-vehicle electrical system, a cable section 3 comprising five individual cables 4 branches off into the cockpit region. In this case, the individual cables 4 may be supply cables and/or communication or bus lines which are connected to a respective one of five electrical components 5 to 9. To this end, the electrical components 5 to 9 each have an interface 10a to 14a, which interfaces 10a to 14a are designed as sockets and all differ from one another. The mating pieces, the connection plugs 10b to 14b, which fit into the sockets are located on the respective component-side end of the individual cables 4. The cable section 3 is formed by combining all of the individual cables 4 by a common covering. This covering is no longer present at the component-side end of the individual cables 4, so that the individual cables 4 are freed from the cable section 3 and the connection plugs 10b to 14b are able to form a connection with the interfaces 10a to 14a. In this case, it is necessary to ensure that the connection plugs 10b to 14b are exactly assigned to the associated interface 10a to 14a. The cockpit cable harness 1 therefore comprises the main connection point 2, the cable section 3 with the individual cables 4, and also the connection plugs 10b to 14b.

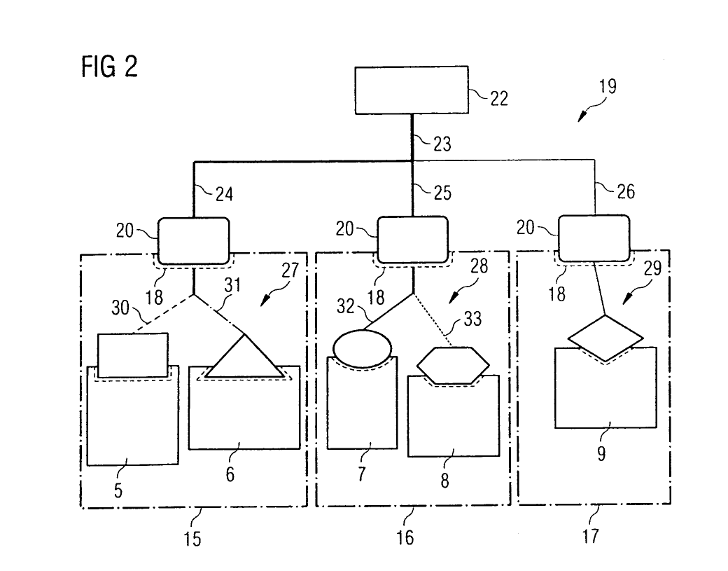

FIG. 2 illustrates the same components 5 to 9 as FIG. 1. The components 5 and 6 are arranged within a module 15, the components 7 and 8 are arranged within a module 16, and the component 9 is arranged within a module 17. Each of the modules 15 to 17 has an interface 18, which interfaces are designed as sockets, are identical, and have the same pin assignment. The mating pieces are identical connection plugs, the module connection points 20, which are fitted on the cockpit cable harness 19. The cockpit cable harness 19 accordingly comprises only a main connection point 22, a cable section 23 with two subordinate cable sections 24, 25 and an individual cable 26, and also three identical module connection points 20. Special assignment is no longer necessary when connecting the module connection points 20 to the sockets 18. Within the modules 15 to 17, the electrical components 5 to 9 are connected to the respective socket 18 and therefore to the module connection point 20 of the cockpit cable harness 19 by means of module cable harnesses 27, 28 and 29. In the module cable harness 27 of the module 15, the individual cables 30 and 31 which lead to the components 5 and 6 are surrounded by a common covering in the vicinity of the socket 18. This covering disappears in the direction of the component-side end of the individual cables 30 and 31, so that the components 5 and 6 can be connected individually. Analogously, the module cable harness 28 of the module 16 contains two individual cables 32 and 33 which lead to the modules 7 and 8.

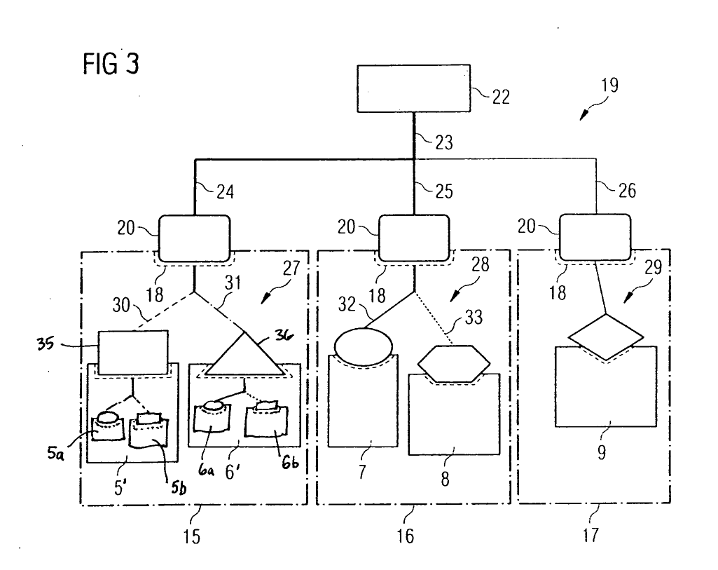

FIG. 3 is similar to FIG. 2, but includes submodules 5′, 6′ instead of component 5, 6. The submodule 5′ includes two electronic components 5a, 5b and the submodule 6′ includes two electronic components 6a, 6b. accordingly, the electrical components 5a, 5b, 6a, 6a within module 15 are each assigned to one of the submodules 5′, 6′. Thus the cables 30, 31 are each connected by subordinate connection points 35, 36 to the submodules 5′, 6′. The electrical components 5a, 5b, 6a, 6b are connected to the subordinate connection points by submodule cable harness.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A cable harness for connecting electrical components in a cockpit of a motor vehicle to an on-board motor vehicle electrical system, each of the electrical components belonging to one of at least two modules, the cable harness comprising:
a cockpit cable harness having only a single main connection point arranged and dimensioned for connection to the on-board motor vehicle electrical system and module connection points, each of the module connection points being arranged and dimensioned for connection to a respective one of the at least two modules; and
module cable harnesses, wherein each of the module cable harnesses corresponds to a respective one of the at least two modules, and wherein each of the electrical components is connectable to one of the module connection points by one of the module cable harnesses.

2. The cable harness of claim 1, wherein one of the two submodules includes two submodules, each of the electrical components of one of the at least two modules are arranged in one of the two submodules, said module cable harness for said one of said the at least two modules having a subordinate connection point to each of the two submodules, and a submodule cable harness connecting each of the electrical components to one of said subordinate connection points.

3. The cable harness of claim 1, wherein said module connection points are of identical design.

4. The cable harness of claim 1, wherein at least one of said single main connection point and said module connection points comprise plug connectors.

5. The cable harness of claim 1, wherein said module connection points comprise plug connectors having identical pin assignments.

6. The cable harness of claim 1, wherein said cockpit cable harness includes at least two cables surrounded by a common covering.

7. The cable harness of claim 1, wherein at least one of the module cable harnesses includes at least two electrical cables surrounded by a common covering.
